(19) United States
(12) Patent Application Publication
(10) Pub. No.: US 2004/0266337 A1
(43) Pub. Date: Dec. 30, 2004

(54) Method and apparatus for synchronizing lyrics

(75) Inventors: Mark J. Radcliffe, Seattle, WA (US); Patrick Sweeney, Redmond, WA (US); Kipley J. Olson, Seattle, WA (US)

Correspondence Address: LEE & HAYES PLLC, 421 W RIVERSIDE AVENUE SUITE 500, SPOKANE, WA, 99201

(73) Assignee: MICROSOFT CORPORATION, REDMOND, WA (US)

(21) Appl. No.: 10/607,194

(22) Filed: Jun. 25, 2003

(51) Int. Cl. H04H 7/00

(52) U.S. Cl. 455/3.06

(57) ABSTRACT

A request is received to play an audio file. A process identifies a preferred language for displaying lyrics associated with the audio file. The process also identifies lyric data associated with the audio file and associated with the preferred language. The audio file is then played while the identified lyric data is displayed.

### TECHNICAL FIELD

The systems and methods described herein relate to synchronizing lyrics with playback of an audio file.

### BACKGROUND

Computer systems are being used today to store various types of media, such as audio data, video data, combined audio and video data, and streaming media from online sources. Lyrics (also referred to as “lyric data”) are available for many audio files, such as audio files copied from a Compact Disc (CD) or downloaded from an online source. However, many of these lyrics are “static”, meaning that they are merely a listing of the lyrics in a particular song or other audio file. These “static” lyrics are not synchronized with the actual music or other audio signals in the song or audio file. An example of static lyrics is the printed listing provided with an audio CD (typically inserted into the front cover of the CD jewel case).

A user can play audio data through a computer system using, for example, a media player application. In this situation, static lyrics may be displayed while the media player application plays audio data, such as an audio file.

To enhance the user experience when playing an audio file, it is desirable to display a portion of the lyrics that correspond to the portion of the audio file being played. Thus, the displayed lyrics change as the audio file is played.

### SUMMARY

The methods and apparatus described herein synchronize the display of lyrics with playback of audio data, such as an audio file. In a particular embodiment, a request is received to play an audio file. A process identifies a preferred language for displaying lyrics associated with the audio file. The process also identifies lyric data associated with the audio file and associated with the preferred language. The audio file is played while the identified lyric data is displayed.

### BRIEF DESCRIPTION OF THE DRAWINGS

Similar reference numbers are used throughout the figures to reference like components and/or features.

FIG. 1 is a block diagram illustrating an example lyric synchronization module.

FIG. 2 is a flow diagram illustrating an embodiment of a procedure for playing an audio file and displaying the corresponding lyrics.

FIGS. 3A-3C illustrate sequences for displaying lyric segments related to an audio file, including jumps to different parts of the audio file.

FIG. 4 illustrates an example arrangement of time codes and associated lyrics for multiple languages.

FIG. 5 illustrates a user interface generated by an example synchronized lyric editor.

FIG. 6 is a flow diagram illustrating an embodiment of a procedure for editing an audio file.

FIG. 7 is a flow diagram illustrating an embodiment of a procedure for converting static lyrics to synchronized lyrics.

FIG. 8 illustrates a general computer environment, which can be used to implement the techniques described herein.

### DETAILED DESCRIPTION

The systems and methods discussed herein synchronize display of lyrics with playback of audio data (e.g., from an audio file). The lyrics may be the words of a song, the words of a spoken dialog, words describing the audio data, or any other words or text associated with audio data. In one implementation, a portion of the lyrics (referred to as a lyric segment) is displayed that corresponds to the portion of the audio data currently being played. As the audio data is played, the displayed lyric segment changes to stay current with the audio data. This synchronization of lyrics with audio data enhances the user's entertainment experience.

As used herein, the term “audio file” describes any collection of audio data. An “audio file” may contain other information in addition to audio data, such as configuration information, associated video data, lyrics, and the like. An “audio file” may also be referred to as a “media file”.

Although particular examples discussed herein refer to playing audio data from CDs, the systems and methods described herein can be applied to any audio data obtained from any source, such as CDs, DVDs (digital video disks or digital versatile disks), video tapes, audio tapes and various online sources. The audio data processed by the systems and methods discussed herein may be stored in any format, such as a raw audio data format or other format such as WMA (Windows Media Audio), MP3 (MPEG, audio layer 3), WAV (a format for storing sound in Files—uses “.wav” filename extension), WMV (Windows Media Video), or ASF (Advanced Streaming Format).

Particular examples discussed herein refer to media players executing on computer systems. However, the systems and methods discussed herein can be applied to any system capable of playing audio data and displaying lyrics, such as portable media devices, personal digital assistants (PDAs), any computing device, cellular phones, etc.

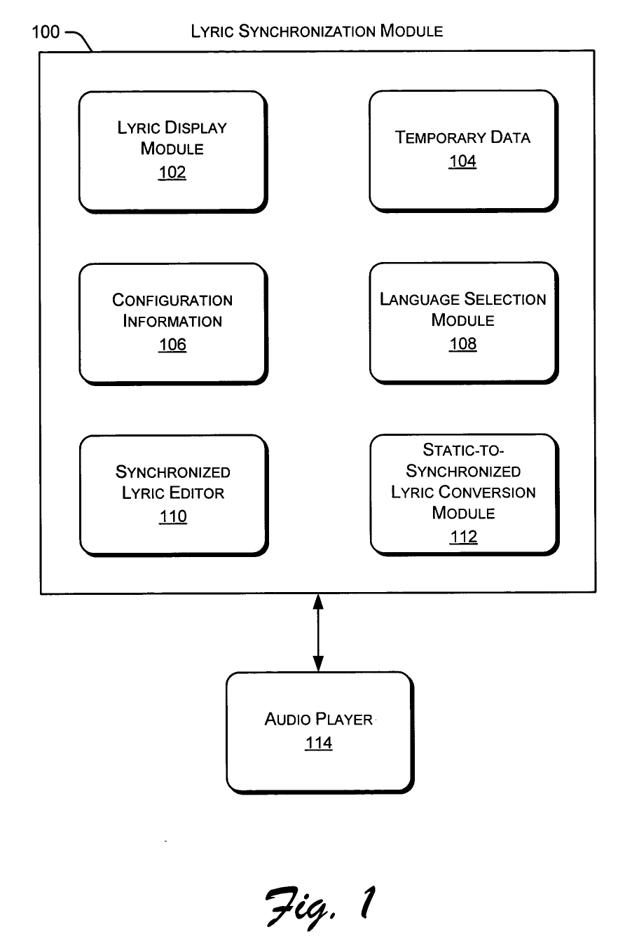

FIG. 1 is a block diagram illustrating an example lyric synchronization module 100 coupled to an audio player 114. Audio player 114 may be a dedicated audio player or may be a media player, such as the Windows Media® Player available from Microsoft Corporation of Redmond, Wash. A media player is typically capable of playing various types of media, such as audio files, video files, and streaming media content. Lyric synchronization module 100 may be coupled to any number of audio players and/or media players. In a particular embodiment, lyric synchronization module 100 is incorporated into a media player or an audio player.

A typical media player or audio player is capable of displaying various information about the media file or audio file being played. For example, an audio player may display the name of the current song, the name of the artist, the name of the album, a listing of other songs on the same album, and the like. The audio player is also capable of displaying static lyric data or synchronized lyric data associated with an audio file.

In a particular embodiment, a media player has a display area used to display closed captioning information, if available. In this media player, that same display area can be used to display synchronized lyrics or static lyrics. In this player, if closed captioning information is available, it is displayed in that display area. If closed captioning information is not available, synchronized lyrics are displayed in that display area during playback of an audio file. If neither closed captioning information nor synchronized lyrics are available, static lyrics are displayed in the display area during playback of the audio file.

Lyric synchronization module 100 includes a lyric display module 102, which generates display data containing lyrics associated with an audio file or other audio data. Lyric display module 102 generates changing lyric data to correspond with an audio file as the audio file is played. In one embodiment, the lyric data is stored in the associated audio file. In another embodiment, the lyric data is stored separately from the audio file, such as in a separate lyric file or in lyric synchronization module 100. Alternatively, lyric data can be stored in a media library or other mechanism used to store media-related data.

Lyric synchronization module 100 also includes a temporary data storage 104, which is used to store, for example, temporary variables, lyric data, audio data, or any other data used or generated during the operation of lyric synchronization module 100. Lyric synchronization module 100 further includes configuration information 106, which includes data such as language preferences, audio playback settings, lyric display settings, and related information. This configuration information 106 is typically used during the execution of lyric synchronization module 100.

Lyric synchronization module 100 also includes a language selection module 108, which determines one or more preferred languages and identifies lyric data associated with the one or more preferred languages. Language selection module 108 also identifies one or more preferred sublanguages, as discussed in greater detail below. Language selection module 108 is also capable of determining the most appropriate lyric data based on the preferred languages, the preferred sublanguages, and the available lyric data. In one embodiment, language selection module 108 stores language and sublanguage preferences for one or more users.

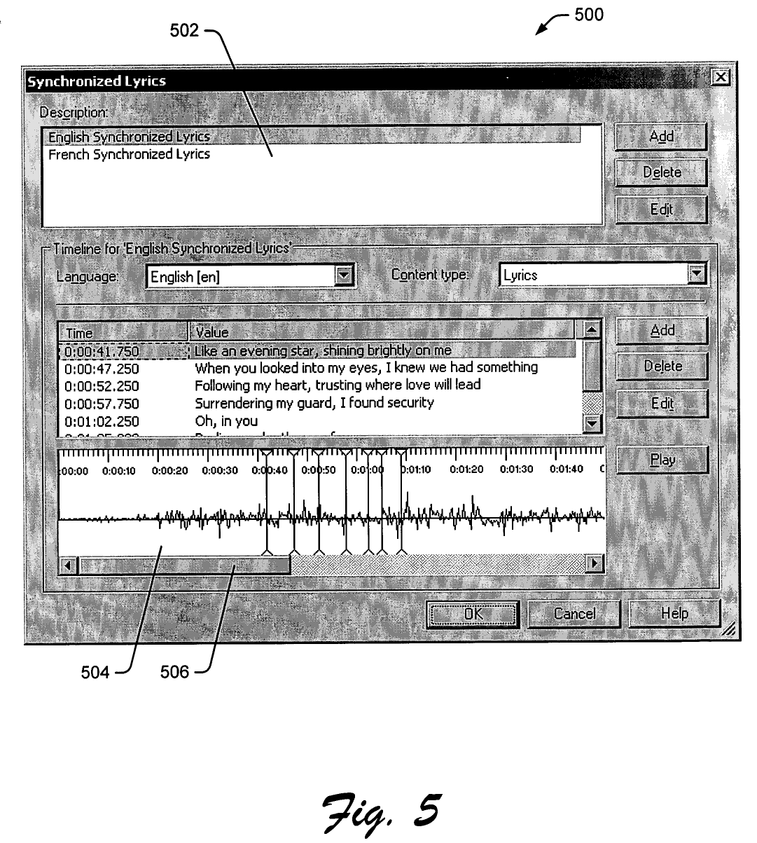

Lyric synchronization module 100 further contains a synchronized lyric editor 110, which allows a user to add lyric data to an audio file, edit existing lyric data, add lyric data for a new language or sublanguage, and the like. Additional details regarding the synchronized lyric editor 110 are provided below with respect to FIG. 5.

Lyric synchronization module 100 also includes a static-to-synchronized lyric conversion module 112. Conversion module 112 converts static lyric data into synchronized lyric data that can be displayed synchronously as an audio file is played. Conversion module 112 may work with synchronized lyric editor 110 to allow a user to edit the converted synchronized lyric data.

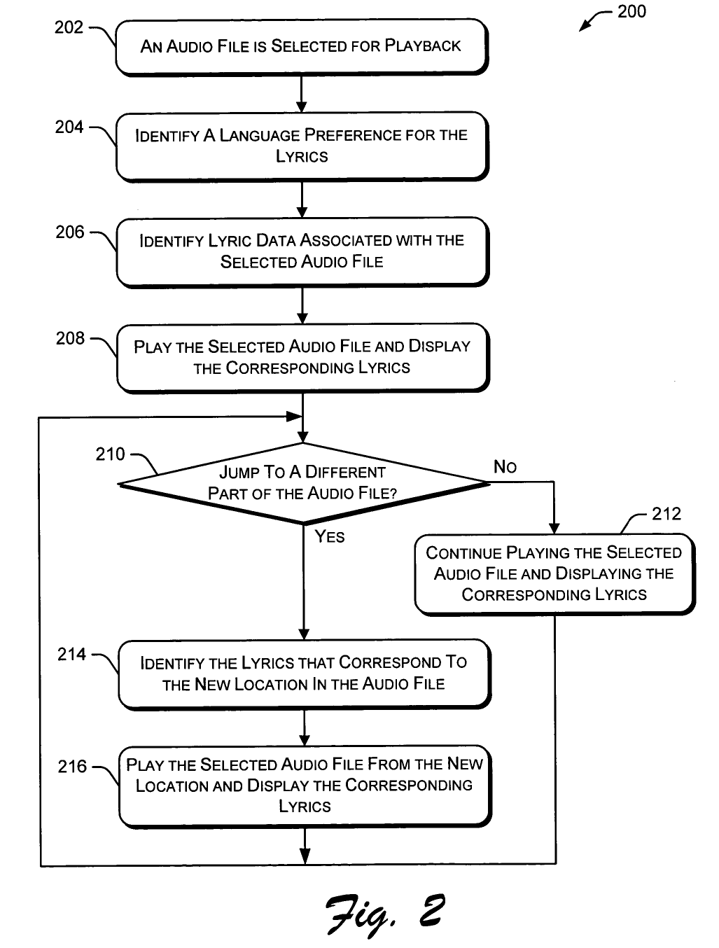

FIG. 2 is a flow diagram illustrating an embodiment of a procedure 200 for playing an audio file and displaying the corresponding lyrics. Initially, an audio file is selected for playback (block 202). The procedure identifies a language preference for the lyrics (block 204). As discussed below, this language preference may also include a sublanguage preference. For example, a language preference is “English” and a sublanguage preference is “United Kingdom”. The procedure then identifies lyric data associated with the selected audio file (block 206). The lyric data may be stored in the audio file or retrieved from some other source, such as an online lyric database, a network server, or any other storage device.

After identifying the lyric data, the procedure plays the selected audio file and displays the corresponding lyrics (block 208). The procedure continues playing the audio file and displaying the corresponding lyrics (block 212) until the end of the audio file is reached or an instruction is received to play a different portion of the audio file (also referred to as “jumping” or “skipping” to a different portion of the audio file). If an instruction is received to jump to a different part of the audio file (block 210), the procedure identifies the lyrics that correspond to the new location in the audio file (block 214). The procedure then plays the selected audio file from the new location and displays the corresponding lyrics (block 216). The procedure then returns to block 210 to determine whether another jump instruction has been received.

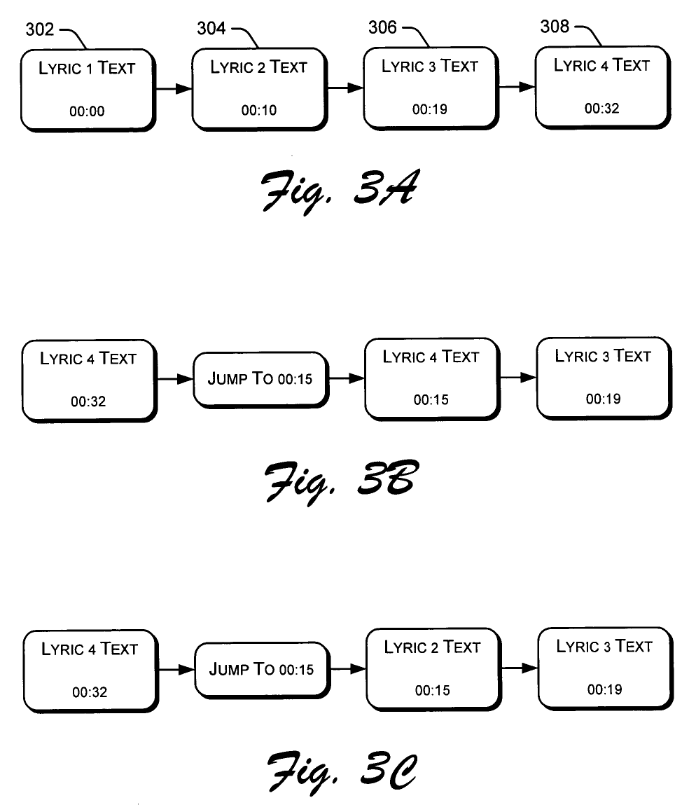

FIGS. 3A-3C illustrate sequences for displaying lyric segments related to an audio file, including jumps to different parts of the audio file. Lyric data for a particular audio file is divided into multiple lyric segments. Each lyric segment is associated with a particular time period in the audio file. Each lyric segment is displayed during the corresponding time period during which the audio file is playing. Each time period is associated with a time code that identifies the beginning of the associated time period. The time code identifies a time offset from the beginning of the audio file. For example a time code “01:15” is located one minute and fifteen seconds from the beginning of the audio file.

FIG. 3A illustrates four sequential lyric segments 302, 304, 306 and 308, and their associated time codes. In this example, lyric segment 302 has an associated time code of “00:00” (i.e., the beginning of the audio file). Lyric segment 302 is displayed from the beginning of the audio file until the next time code “00:10” (i.e., ten seconds into the audio file) at which point lyric segment 304 is displayed. Lyric segment 304 is displayed until “00:19” followed by lyric segment 306 until “00:32”, when lyric segment 308 is displayed.

In a particular embodiment, the lyric data and corresponding time codes are read from the audio file when the audio file first begins playing. As the audio file plays, the audio player or lyric synchronization module checks the current time position of the audio file versus the time codes in the synchronized lyrics information. If there is a match, the corresponding lyric segment is displayed.

If an instruction to jump to a different part of the audio file is received, the display of lyrics can be handled in different manners. A jump instruction may be executed by dragging and releasing a seek bar button in an audio player or a media player. FIG. 3B illustrates one method of handling lyrics when jumping to a different part of the audio file. In this example, the lyric display module 102 waits until the current time position of the file matches a time code before changing the displayed lyric. Thus, as shown in FIG. 3B, “Lyric 4 Text” continues to be shown at “00:15” because the next time code (“00:19”) has not yet been reached. When time code “00:19” is reached, the lyric text is updated to the correct “Lyric 2 text”.

FIG. 3C illustrates another method of handling lyrics when jumping to a different part of the audio file. In this example, the lyric display module 102 scans all time codes and associated lyric data to determine the highest time code that is still less than the new time position and displays the corresponding lyric segment immediately (rather than waiting until receiving the next time code). Thus, as shown in FIG. 3C, “Lyric 2 Text” is displayed after the jump to “00:15”.

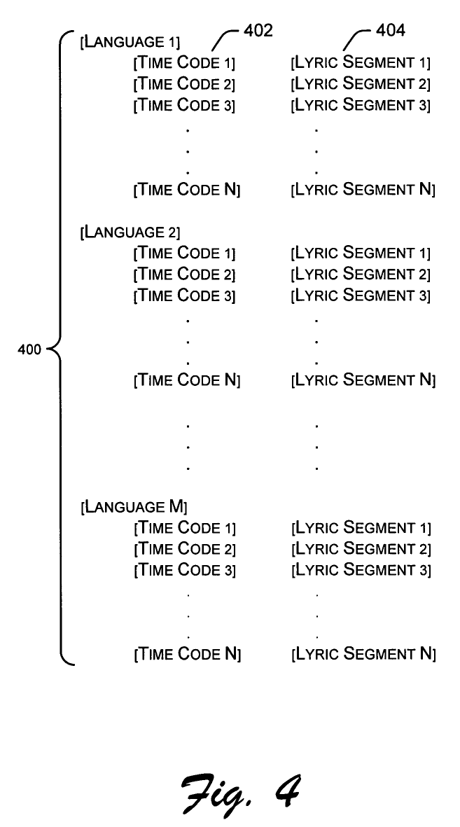

FIG. 4 illustrates an example arrangement of time codes and associated lyrics for multiple languages 400. The data shown in FIG. 4 may be stored in an audio file with which the data is associated or stored in another file separate from the audio file. Lyrics for a particular audio file may be available in any number of languages. For each language, the lyrics for the audio file are separated into multiple lyric segments 404 and corresponding time codes 402. For example, for “Language 1” in FIG. 4, the lyrics are separated into N lyric segments, each of which has a corresponding time code. Thus, “Time Code 1” corresponds to “Lyric Segment 1”, “Time Code 2” corresponds to “Lyric Segment 2”, and so on until the last lyric segment “Lyric Segment N” is identified as being associated with “Time Code N”. A particular language (and therefore a particular audio file) may have any number of associated lyric segments and corresponding time codes.

Specific embodiments described herein implement lyric synchronization functions into or in combination with media players, audio players or other media-related applications. In an alternate embodiment, these lyric synchronization functions are provided as events that can be generated through an existing object model. For example, an event may send lyrics, lyric segments, or time codes to other devices or applications via Active-X® controls. A particular example of an object model is the Windows Media® Player object model, which is a collection of APIs that expose the functionality (including synchronized lyrics) of the Windows Media® Player to various software components.

The object model supports “events”. These events are reported to any software component that is using the object model. Events are associated with concepts that change as a function of time (in contrast to concepts that are “static” and do not change). An example of an event is a change in the state of a media player, such as from “stopped” to “playing” or from “playing” to “paused”. In one embodiment of an object model, a generalized event could be defined that denotes that the currently playing file contains a data item that has a significance at a particular time position. Since this event is generalized, the object model can support multiple different kinds of time-based data items in the file. Examples include closed caption text or URL addresses such that an associated HTML browser can display a web page corresponding to a particular time in the media file.

In one embodiment of an object model, the generalized event can be used to inform software components that a synchronized lyric data item that pertains to the current media time position is present. Therefore, software components can be notified of the synchronized lyric data item at an appropriate time and display the lyric data to the user. This provides a mechanism for software components to provide synchronized lyrics without needing to examine the file, extract the lyric data and time codes, and monitor the time position of a currently playing file.

A particular embodiment of a generalized event is the “Player.ScriptCommand” event associated with the Windows Media Player®. The Player.ScriptCommand event occurs when a synchronized command or URL is received. Commands can be embedded among the sounds and images of a Windows Media® file. The commands are a pair of Unicode strings associated with a designated time in the data stream. When the data stream reaches the time associated with the command, the Windows Media® Player sends a ScriptCommand event having two parameters. A first parameter identifies the type of command being sent. A second parameter identifies the command. The type of parameter is used to determine how the command parameter is processed. Any type of command can be embedded in a Windows Media® stream to be handled by the ScriptCommand event.

Some audio files are generated without any synchronized lyric information contained in the audio file. For these audio files, a user needs to add lyric information to the audio file (or store in another file) if they want to view synchronized lyrics as the audio file is played. Certain audio files may already include static lyric information. As discussed above, “static” lyric information is a listing of all lyrics in a particular song or other audio file. These static lyrics are not synchronized with the actual music or audio data. The static lyrics are not separated into lyric segments and do not have any associated time codes.

FIG. 5 illustrates a user interface 500 generated by an example synchronized lyric editor, such as synchronized lyric editor 110 (FIG. 1). A description area 502 lists the multiple sets of lyrics available to edit. The “Add” button next to description area 502 adds a new synchronized lyrics set, the “Delete” button deletes the selected synchronized lyrics set, and the “Edit” button initiates editing of the name of the selected synchronized lyrics set.

A “Timeline” area below description area 502 lists the detailed synchronization lyric information for the selected set of lyrics. The “Language” area specifies the language for the synchronized lyrics set and the “Content type” area specifies the content type for the synchronized lyrics set. Other content types include text, movement, events, chord, trivia, web page, and images. A particular embodiment may support any number of different content types. Additionally, users can specify one or more different content types.

The “Time” heading specifies a particular time code in the synchronized lyrics set and the “Value” heading specifies an associated lyric in the synchronized lyrics set. The “Add” button adds a time code/lyric segment pair in the synchronized lyrics set and the “Delete” button deletes a time code/lyric segment pair from the set. The “Edit” button allows the user to modify the selected time code or lyric segment.

The graph window 504, below the Time/Value listing, displays a waveform of the audio file along a time axis. The seven vertical bars shown in graph window 504 correspond to time codes. When a time code/lyric segment pair is selected in the Time/Value listing, the corresponding vertical bar in graph window 504 is highlighted. In the example of FIG. 5, the waveform is larger than the available display area. Thus, a horizontal scroll bar 506 is provided that allows a user to scroll the waveform from side to side.

The “Play” button to the right of graph window 504 begins playing the audio file starting with the selected time code/lyric segment pair. The “OK” button accepts all changes and saves the edited synchronized lyrics. The “Cancel” button discards all changes and does not save the edited synchronized lyrics. The “Help” button displays help to the user of the synchronized lyric editor.

The user interface shown in FIG. 5 does not restrict an end user to a particular sequence of actions. When a user switches from one set of synchronized lyrics to another, all of the current information inside the Timeline area (e.g., language, content type, and time code/lyric segment pairs) is retained and re-displayed if that set of synchronized lyrics is selected again.

A user can adjust a time code by editing the “Time” data in the Time/Value listing or by moving the vertical bar (e.g., with a mouse or other pointing device) associated with the time code in the graph window 504. If the user adjusts the “Time” data, the position of the associated vertical bar is adjusted accordingly. Similarly, if the user adjusts the vertical bar, the associated “Time” data is updated accordingly.

When a user has finished creating or editing the synchronized lyrics for an audio file and selects the “OK” button, the information needs to be written to the audio file. If the audio file is already open (e.g., the audio file is currently being played by the user), the synchronized lyrics cannot be written to the audio file. In this situation, the synchronized lyrics are cached while the audio file is open. If the synchronized lyrics information is needed before the audio file has been updated (e.g., the user activates the display of synchronized lyrics or further edits the synchronized lyrics information), the system checks the cache before checking the audio file. When the audio file is finally closed, the cached synchronized lyrics information is then written out to the audio file and the cached information is cleared.

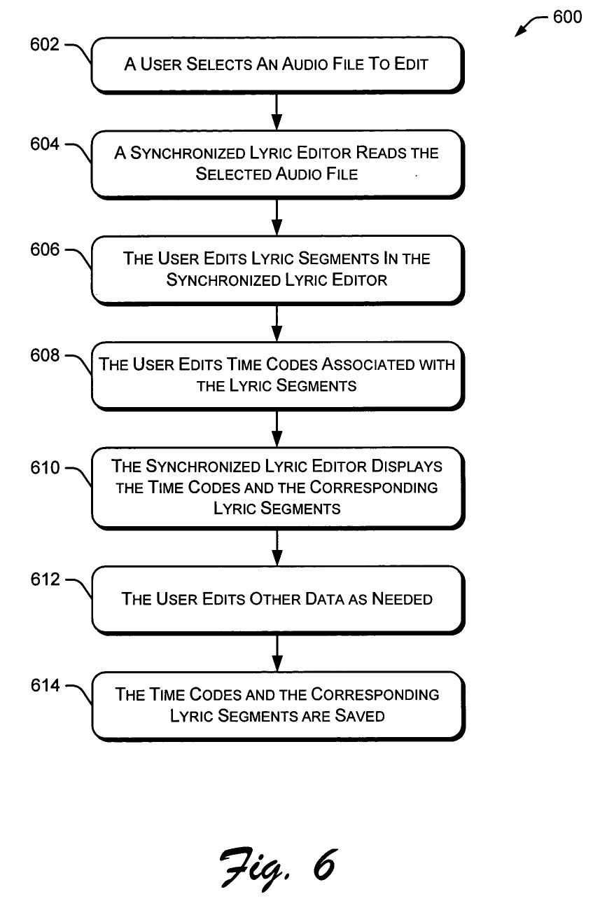

FIG. 6 is a flow diagram illustrating an embodiment of a procedure 600 for editing an audio file. Initially, a user selects an audio file to edit (block 602). A synchronized lyric editor reads the selected audio file (block 604). As needed, the user edits lyric segments in the synchronized lyric editor (block 606). Additionally, the user edits time codes associated with the lyric segments, as needed (block 608). The synchronized lyric editor then displays the edited time codes and the corresponding edited lyric segments (block 610). The user then edits other data (such as a description of the lyrics or a language associated with the lyrics), as needed (block 612). Finally, the time codes and the corresponding lyric segments, as well as other data, are saved, for example, in the audio file (block 614).

When formatting static lyrics, each lyric is typically terminated with a <return>character or <return><line feed>characters to denote the end of the lyric. Since static lyrics have no time code information, static lyrics are typically displayed in their entirety for the duration of the audio file playback. Verses and choruses are typically separated by an empty lyric, i.e., a lyric that contains a single <return>character or the <return><line feed>characters.

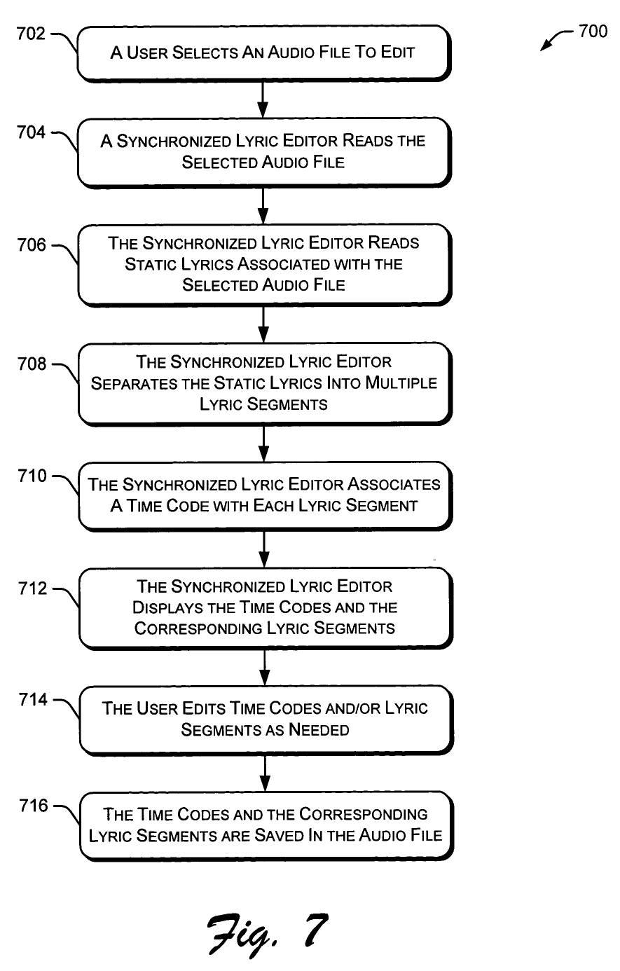

Instead of requiring a user to type in the static lyrics, static lyrics can be converted to synchronized lyrics. FIG. 7 is a flow diagram illustrating an embodiment of a procedure 700 for converting static lyrics to synchronized lyrics. Initially, a user selects an audio file to edit (block 702). A synchronized lyric editor reads the selected audio file (block 704). The synchronized lyric editor also reads static lyrics associated with the selected audio file (block 706). The synchronized lyric editor then separates the static lyrics into multiple lyric segments (block 708). This separation of the static lyrics may include ignoring any empty or blank lines or sections of the static lyrics (e.g., blank sections between verses). The multiple lyric segments are separated such that all lyric segments are approximately the same size (e.g., approximately the same number of characters or approximately the same audio duration). The synchronized lyric editor associates a time code with each lyric segment (block 710). The synchronized lyric editor then displays the time codes and the corresponding lyric segments (block 712). The user is able to edit the time codes and/or lyric segments as needed (block 714). Finally, the time codes and the corresponding lyric segments are saved in the audio file (block 716).

In another embodiment, empty or blank lines or sections of the static lyrics are considered to represent a larger pause between lyrics. In this embodiment, the multiple lyric segments are separated such that all lyric segments are approximately the same size. Then, the empty or blank lines or sections are removed from the appropriate lyric segments. Otherwise, the remaining portions of FIG. 7 are followed for this embodiment.

When an audio player begins playing a file (such as an audio file) and the user has requested that synchronized lyrics be shown, the audio player automatically selects one set of synchronized lyrics from the audio file (or another lyric source). A problem arises if none of the sets of synchronized lyrics match the user's preferred language. This problem can be solved by prioritizing all sets of synchronized lyrics according to their language and choosing a set to display based on a priority order. Languages are typically classified according to their “language” and “sublanguage”, where “language” is the basic language (such as “English”, “French”, or “German) and “sublanguage” is a country/region/dialect subcategory. For example, sublanguages of “English” are “UK” and “US” and sublanguages of “French” are “Canada” and “Swiss”. If no sublanguage is specified, the language is considered generic, such as generic English or generic German.

In one embodiment, the following priority list is used to select a particular set of lyrics to display with a particular audio file. If a particular set of lyrics does not exist in the audio file, the next entry in the priority list is considered. If multiple matches exist for the same priority level, then the first matching set of lyrics is the audio file is selected for display.

1. SL Language=User Language AND SL Sublanguage=User Sublanguage

2. SL Language=User Language AND SL Sublanguage=<Not Specified>

3. SL Language=User Language AND SL Sublanguage≠User Sublanguage

4. SL Language =English AND SL Sublanguage=United States

5. SL Language =English AND SL Sublanguage=<Not Specified>

6. SL Language=English AND SL Sublanguage≠United States or <Not Specified>

7. SL Language≠User Language

8. SL Language <Not Specified>AND SL Sublanguage =<Not Specified>

Where:

SL Language=Synchronized Lyrics Language

SL Sublanguage=Synchronized Lyrics Sublanguage

User Language=Preferred Language of current user of audio player

User Sublanguage=Preferred Sublanguage of current user

This priority list takes into the account the variances in language/ sublanguage specifications (although a sublanguage need not be specified) as well as error conditions (e.g., no language/sublanguage specified). In addition, the priority list gives priority to a user's preferred language over English, which in turn has priority over any other languages that may be in the audio file. It is not necessary to search the entire audio file eight times looking for a potential priority match. Instead, the audio file can be searched once and the results of all eight priorities are evaluated as the audio file is searched. The results of these evaluations are considered to determine the “highest” match.

In a particular example, the user's preferred language-sublanguage is “French-Canada”. If the three lyric sets available are 1) French, 2) French Canada, and 3) German-Swiss, the “French-Canada” set is chosen due to the exact match. In another example, the three lyric sets available are 1) French, 2) French Swiss, and 3) German-Swiss. In this example, “French” is chosen due to the mismatch of sublanguages with “French-Swiss”. In a further example, the three lyric sets available are 1) Danish-Denmark, 2) French-Swiss, and 3) German-Swiss. In this example, “French-Swiss” is chosen due to the language match. In another example, the three lyric sets available are 1) English-US, 2) English-UK, and 3) German. In this example, “English-US” is selected because there was no language match.

If a particular audio file has more than one set of synchronized lyrics, a user may want to display one of the alternate sets of synchronized lyrics. This can be accomplished by displaying a list of all available synchronized lyrics from which the user can select the desired set of synchronized lyrics. If the user selects an alternate set of synchronized lyrics, that alternate set is used during the current playback session. If the same audio file is played at a future time, the appropriate set of synchronized lyrics are identified and displayed during playback of the audio file.

In a particular embodiment a separate time code may be associated with each word of an audio file's lyrics. Thus, each word of the lyrics can be displayed individually at the appropriate time during playback of the audio file. This embodiment is similar to those discussed above, but the lyric segments are individual words rather than strings of multiple words.

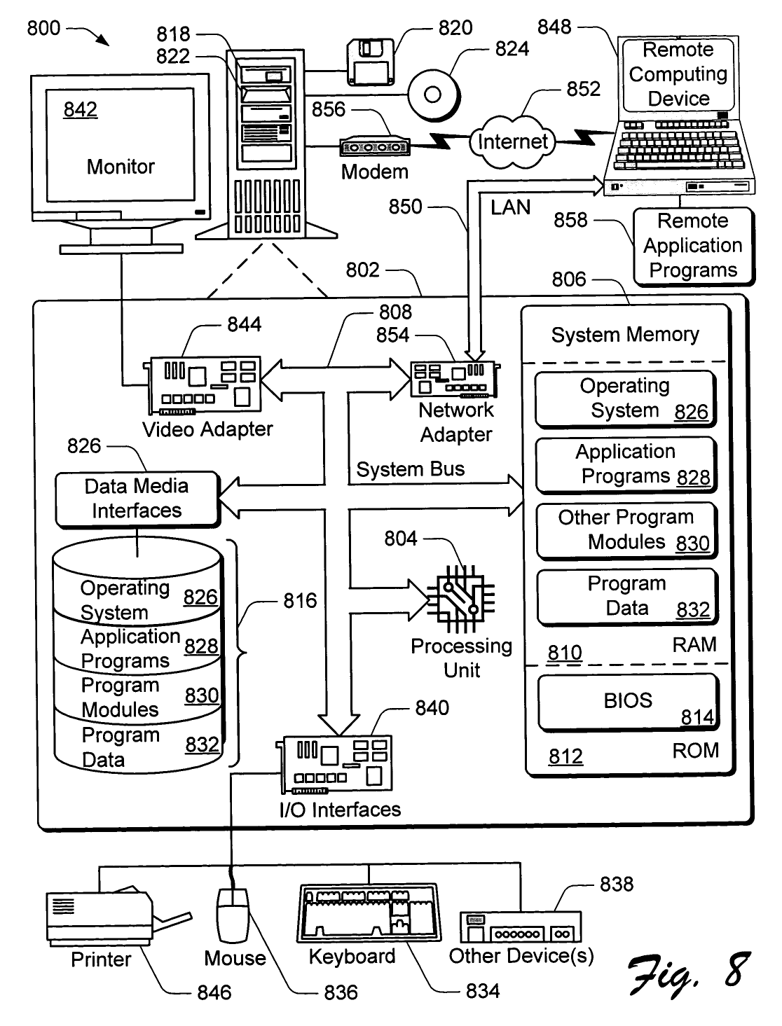

FIG. 8 illustrates a general computer environment 800, which can be used to implement the techniques described herein. The computer environment 800 is only one example of a computing environment and is not intended to suggest any limitation as to the scope of use or functionality of the computer and network architectures. Neither should the computer environment 800 be interpreted as having any dependency or requirement relating to any one or combination of components illustrated in the example computer environment 800.

Computer environment 800 includes a general-purpose computing device in the form of a computer 802. One or more media player applications and/or audio player applications can be executed by computer 802. The components of computer 802 can include, but are not limited to, one or more processors or processing units 804 (optionally including a cryptographic processor or co-processor), a system memory 806, and a system bus 808 that couples various system components including the processor 804 to the system memory 806.

The system bus 808 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 802 typically includes a variety of computer readable media. Such media can be any available media that is accessible by computer 802 and includes both volatile and non-volatile media, removable and non-removable media.

The system memory 806 includes computer readable media in the form of volatile memory, such as random access memory (RAM) 810, and/or non-volatile memory, such as read only memory (ROM) 812. A basic input/output system (BIOS) 814, containing the basic routines that help to transfer information between elements within computer 802, such as during start-up, is stored in ROM 812. RAM 810 typically contains data and/or program modules that are immediately accessible to and/or presently operated on by the processing unit 804.

Computer 802 may also include other removable/non-removable, volatile/non-volatile computer storage media. By way of example, FIG. 8 illustrates a hard disk drive 816 for reading from and writing to a non-removable, non-volatile magnetic media (not shown), a magnetic disk drive 818 for reading from and writing to a removable, non-volatile magnetic disk 820 (e.g., a “floppy disk”), and an optical disk drive 822 for reading from and/or writing to a removable, non-volatile optical disk 824 such as a CD-ROM, DVD-ROM, or other optical media. The hard disk drive 816, magnetic disk drive 818, and optical disk drive 822 are each connected to the system bus 808 by one or more data media interfaces 826. Alternatively, the hard disk drive 816, magnetic disk drive 818, and optical disk drive 822 can be connected to the system bus 808 by one or more interfaces (not shown).

The disk drives and their associated computer-readable media provide non-volatile storage of computer readable instructions, data structures, program modules, and other data for computer 802. Although the example illustrates a hard disk 816, a removable magnetic disk 820, and a removable optical disk 824, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the example computing system and environment.

Any number of program modules can be stored on the hard disk 816, magnetic disk 820, optical disk 824, ROM 812, and/or RAM 810, including by way of example, an operating system 826, one or more application programs 828, other program modules 830, and program data 832. Each of such operating system 826, one or more application programs 828, other program modules 830, and program data 832 (or some combination thereof) may implement all or part of the resident components that support the distributed file system.

A user can enter commands and information into computer 802 via input devices such as a keyboard 834 and a pointing device 836 (e.g., a “mouse”). Other input devices 838 (not shown specifically) may include a microphone, joystick, game pad, satellite dish, serial port, scanner, and/or the like. These and other input devices are connected to the processing unit 804 via input/output interfaces 840 that are coupled to the system bus 808, but may be connected by other interface and bus structures, such as a parallel port, game port, or a universal serial bus (USB).

A monitor 842 or other type of display device can also be connected to the system bus 808 via an interface, such as a video adapter 844. In addition to the monitor 842, other output peripheral devices can include components such as speakers (not shown) and a printer 846 which can be connected to computer 802 via the input/output interfaces 840.

Computer 802 can operate in a networked environment using logical connections to one or more remote computers, such as a remote computing device 848. By way of example, the remote computing device 848 can be a personal computer, portable computer, a server, a router, a network computer, a peer device or other common network node, game console, and the like. The remote computing device 848 is illustrated as a portable computer that can include many or all of the elements and features described herein relative to computer 802.

Logical connections between computer 802 and the remote computer 848 are depicted as a local area network (LAN) 850 and a general wide area network (WAN) 852. Such networking environments are commonplace in offices, enterprise-wide computer networks, intranets, and the Internet.

When implemented in a LAN networking environment, the computer 802 is connected to a local network 850 via a network interface or adapter 854. When implemented in a WAN networking environment, the computer 802 typically includes a modem 856 or other means for establishing communications over the wide network 852. The modem 856, which can be internal or external to computer 802, can be connected to the system bus 808 via the input/output interfaces 840 or other appropriate mechanisms. It is to be appreciated that the illustrated network connections are exemplary and that other means of establishing communication link(s) between the computers 802 and 848 can be employed.

In a networked environment, such as that illustrated with computing environment 800, program modules depicted relative to the computer 802, or portions thereof, may be stored in a remote memory storage device. By way of example, remote application programs 858 reside on a memory device of remote computer 848. For purposes of illustration, application programs and other executable program components such as the operating system are illustrated herein as discrete blocks, although it is recognized that such programs and components reside at various times in different storage components of the computing device 802, and are executed by the data processor(s) of the computer.

Various modules and techniques may be described herein in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.” “Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer. “Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
receiving a request to play an audio file;
identifying a preferred language for displaying lyrics associated with the audio file;
identifying lyric data associated with the audio file and associated with the preferred language; and
playing the audio file and displaying the identified lyric data.

2. A method as recited in claim 1 wherein the identified lyric data is contained in the audio file.

3. A method as recited in claim 1 wherein the identified lyric data is stored separately from the audio file.

4. A method as recited in claim 1 wherein the lyric data includes a plurality of lyric segments, and wherein each of the plurality of lyric segments is associated with a particular time period of the audio file.

5. A method as recited in claim 1 wherein the lyric data includes a plurality of lyric segments and the audio file contains a plurality of time codes, wherein each of the plurality of time codes corresponds to a particular lyric segment.

6. A method as recited in claim 5 wherein a particular lyric segment is displayed during playback of the audio file based on a current time code.

7. A method as recited in claim 1 wherein identifying a preferred language includes identifying a preferred language and a preferred sublanguage.

8. One or more computer-readable memories containing a computer program that is executable by a processor to perform the method recited in claim 1.

9. A method comprising:
receiving a request to play an audio file;
identifying a plurality of lyric segments associated with the audio file, wherein each lyric segment has an associated time code, and wherein each time code identifies a time during playback of the audio file that a corresponding lyric segment is displayed; and
playing the audio file and displaying the appropriate lyric segments as the audio file plays.

10. A method as recited in claim 9 wherein playing the audio file and displaying the appropriate lyric segments includes:
playing the audio file;
identifying a time code associated with a current playback location in the audio file;
identifying a lyric segment associated with the identified time code; and displaying the lyric segment until a subsequent time code is reached.

11. A method as recited in claim 10 wherein a new lyric segment associated with the subsequent time code is displayed when the subsequent time code is reached.

12. A method as recited in claim 9 further comprising:
receiving a request to jump to a different part of the audio file;
identifying a lyric segment associated with the different part of the audio file; and
playing the audio file from the different part of the audio file and displaying the lyric segment.

13. A method as recited in claim 9 wherein the time codes and the lyric segments are stored in the audio file.

14. One or more computer-readable memories containing a computer program that is executable by a processor to perform the method recited in claim 9.

15. A method comprising:
selecting an audio file to edit;
identifying lyric segments associated with the audio file;
assigning a time code to each lyric segment, wherein each time code identifies a temporal location within the audio file; and
saving the time codes and the corresponding lyric segments.

16. A method as recited in claim 15 further comprising displaying the time codes and the corresponding lyric segments.

17. A method as recited in claim 15 further comprising editing one or more time codes.

18. A method as recited in claim 15 wherein saving the time codes and the corresponding lyric segments includes storing the time codes and the corresponding lyric segments in the audio file.

19. A method as recited in claim 15 wherein saving the time codes and the corresponding lyric segments includes storing the time codes and the corresponding lyric segments in a file separate from the audio file.

20. A method as recited in claim 15 wherein saving the time codes and the corresponding lyric segments includes caching the time codes and the corresponding lyric segments if the audio file is currently in use.

21. A method as recited in claim 15 further comprising associating a language with the lyric segments.

22. A method as recited in claim 15 further comprising:
associating a language with the lyric segments; and
associating a sublanguage with the lyric segments.

23. One or more computer-readable memories containing a computer program that is executable by a processor to perform the method recited in claim 15.

24. A method comprising:
selecting an audio file to edit;
identifying static lyrics associated with the audio file;
separating the static lyrics into a plurality of lyric segments;
assigning a time code to each of the plurality of lyric segments, wherein
each time code identifies a temporal location within the audio file; and
saving the time codes and the corresponding lyric segments.

25. A method as recited in claim 24 wherein the static lyrics include all lyrics associated with the audio file.

26. A method as recited in claim 24 wherein the plurality of lyric segments are approximately equal in duration.

27. A method as recited in claim 24 further comprising editing one or more time codes.

28. A method as recited in claim 24 further comprising displaying the time codes and the corresponding lyric segments.

29. A method as recited in claim 24 wherein saving the time codes and the corresponding lyric segments includes storing the time codes and the corresponding lyric segments in the audio file.

30. A method as recited in claim 24 further comprising associating a language with the lyric segments.

31. One or more computer-readable memories containing a computer program that is executable by a processor to perform the method recited in claim 24.

32. A method comprising:
receiving a request to play an audio file;
identifying a preferred language for displaying lyrics;
identifying an alternate language for displaying lyrics;
playing the audio file and displaying associated lyric data in the preferred language if lyric data is available in the preferred language; and
playing the audio file and displaying associated lyric data in the alternate language if lyric data is not available in the preferred language.

33. A method as recited in claim 32 further comprising playing the audio file and displaying associated lyric data in English if lyric data is not available in the preferred language or the alternate language.

34. A method as recited in claim 32 wherein the lyric data is stored in the audio file.

35. A method as recited in claim 32 further comprising:
while playing the audio file, receiving a request to change the language of the lyrics being displayed; and
displaying associated lyric data in the requested language.

36. A method as recited in claim 32 wherein playing the audio file and displaying associated lyric data includes:
playing the audio file;
determining a time code associated with a current playback location in the audio file;
identifying a lyric segment associated with the time code; and
displaying the lyric segment until a different time code is reached.

37. One or more computer-readable memories containing a computer program that is executable by a processor to perform the method recited in claim 32.

38. An apparatus comprising:
an audio player to play an audio file; and
a language selection module to identify a preferred language for displaying lyrics; and
a lyric display module coupled to the audio player and the language selection module, the lyric display module to identify lyric data associated with the audio file and the preferred language, wherein the lyric display module displays the identified lyric data synchronously with playing of the audio file.

39. An apparatus as recited in claim 38 wherein the lyric display module displays different lyric segments based on a portion of the audio file being played by the audio player.

40. An apparatus as recited in claim 38 wherein the lyric data is stored in the audio file.

41. An apparatus as recited in claim 38 wherein the preferred language is stored separately from the audio file.

42. An apparatus as recited in claim 38 further comprising a synchronized lyric editor to edit lyric data associated with audio files.

43. An apparatus comprising:
means for identifying an audio file to play;
means for identifying a plurality of lyric segments associated with the audio file, wherein each lyric segment has an associated time code, and wherein the time codes identify periods of time during playback of the audio file; and
means for playing the audio file and displaying a lyric segment that corresponds to the current time code.

44. An apparatus as recited in claim 43 further comprising means for identifying a preferred language for displaying lyrics, wherein the means for identifying a plurality of lyric segments identifies a plurality of lyric segments in the preferred language.

45. An apparatus as recited in claim 43 wherein the lyric segments are stored in the audio file.

46. One or more computer-readable media having stored thereon a computer program that, when executed by one or more processors, causes the one or more processors to:
receive a request to play an audio file;
identify a preferred language in which to display lyrics associated with the audio file;
identify a plurality of lyric segments associated with the audio file, wherein each lyric segment is associated with the preferred language and each lyric segment has an associated time code, and wherein each time code identifies a time during playback of the audio file that a corresponding lyric segment is displayed; and
play the audio file and display the appropriate lyric segments as the audio file is played.

47. One or more computer-readable media as recited in claim 46 wherein the one or more processors further identify an alternate language if lyric segments are not available in the preferred language.

48. One or more computer-readable media as recited in claim 46 wherein the time code data is stored in the audio file.
